(19) United States
(12) Patent Application Publication
(10) Pub. No.: US 2019/0240624 A1
(43) Pub. Date: Aug. 8, 2019

(54) HYBRID DESALINATION SYSTEM

(71) Applicant: QATAR FOUNDATION FOR EDUCATION, SCIENCE AND COMMUNITY DEVELOPMENT, Washington, DC (US)

(72) Inventor: ABDELNASSAR ABDELKHALEK MABROUK ABOUKHLEWA, DOHA (QA)

(73) Assignee: QATAR FOUNDATION FOR EDUCATION, SCIENCE AND COMMUNITY DEVELOPMENT, DOHA (QA)

(21) Appl. No.: 16/320,442

(22) PCT Filed: Jul. 18, 2017
(86) PCT No.: PCT/US2017/042529

§ 371 Date: Jan. 24, 2019

Related U.S. Application Data
(60) Provisional application No. 62/366,586, filed on Jul. 25, 2016.

(51) Int. Cl. B01D 61/58; B01D 61/00; B01D 61/02; B01D 61/04; B01D 3/14; B01D 5/00; C02F 9/00

(52) U.S. Cl. CPC B01D 61/58; B01D 61/002; B01D 61/025; B01D 61/04; B01D 3/146; C02F 1/04; B01D 5/0072; C02F 9/00; B01D 2311/04; B01D 2311/08; B01D 2311/2669; B01D 5/006

(57) ABSTRACT

The hybrid desalination system (10) includes a reverse osmosis filtration system (14), a forward osmosis filtration system (18), and a multi-effect distillation system (16). A condenser (12) receives seawater (S) and produces cooled seawater (CS). The cooled seawater (CS) is filtered by the reverse osmosis filtration system (14), which outputs a first brine reject stream (BR1) and a permeate stream (P). The multi-effect distillation system (16) outputs a second brine reject stream (BR2). A feed side (20) of the forward osmosis filtration system (18) receives the first brine reject stream (BR1), and the second brine reject stream (BR2) is received by the draw side (22), which outputs diluted brine (DB). The multi-effect distillation system (16) is in fluid communication with the forward osmosis filtration system (18) and recycles the diluted brine (DB). The multi-effect distillation system (16) outputs a return condensate (RC) and a pure water distillate (D).

### TECHNICAL FIELD

The present disclosure relates to desalination, and particularly to a hybrid desalination system that combines reverse osmosis filtration with forward osmosis filtration and multi-effect distillation.

### BACKGROUND ART

Seawater desalination systems are an important technology in many parts of the world where fresh water is difficult to access. Such desalination systems find their greatest practicality in arid areas that are also adjacent to the sea, as in many parts of the Middle East, for example. There are numerous technologies used for the desalination or purification of water, including reverse osmosis filtration and multi-effect distillation among the most common. Reverse osmosis (RO) is a water purification technology that uses a semipermeable membrane to remove ions, molecules and larger particles from drinking water. In reverse osmosis, an applied pressure is used to overcome osmotic pressure, a colligative property that is driven by chemical potential differences of the solvent, a thermodynamic parameter. In other words, RO involves the forcing of a solvent from a region of high solute concentration through a semipermeable membrane to a region of low solute concentration by applying a pressure in excess of the osmotic pressure.

Two parameters for examining the efficiency of the RO process are the recovery ratio for a typical RO filtration system, and the level of boron in the RO system's permeate. Boron naturally exists in water as boric acid (B(OH)₃) and borate ions (B(OH)₂O). The World Health Organization Guidelines for Drinking Water Quality propose a maximum recommended boron concentration of 0.5 mg/L in drinking water. Thus, the removal of boron from water intended for consumption stands as a measure of the effectiveness of a filtration and purification process. Boron is present in seawater at an average concentration of 4-7 mg/L. However, it may be present in regions of high salinity water at concentrations above 7 mg/L, such as in the Persian Gulf.

In order to adapt an RO system for acceptable levels of boron removal with a desired recovery ratio, a two-pass RO system must be used. The first pass uses an RO filtration system with a seawater reverse osmosis (SWRO) membrane, and the second pass uses a secondary RO filtration system with a brackish water reverse osmosis (BWRO) membrane. In such as system, the first pass recovery ratio is about 35% and the recovery ratio of the second pass is about 90%. Although such a two-pass RO system is effective for desalination and removal of boron, the requirement of having a second pass filtration system makes the energy requirements of operating such a system excessive.

Multi-effect distillation (MED) is a water desalination process that distills sea water by converting a portion of the water into vapor in multiple stages, or “effects”, of what are essentially countercurrent heat exchangers. Multi-effect distillation plants produce about 60% of all desalinated water in the world. Although MED requires less energy than the two-pass RO filtration system described above, the energy requirements of MED can still be excessive, particularly since MED operates primarily through heat exchange; i.e., relatively inefficient thermal energy dominates the total energy consumption in MED. Additionally, in order to avoid scale deposition in the effects, salinity must be carefully controlled, which requires lowering the recovery ratio. Thus, a hybrid desalination system solving the aforementioned problems is desired.

### DISCLOSURE

The hybrid desalination system combines a reverse osmosis filtration system and a forward osmosis filtration system with a multi-effect distillation system. In a first mode, configured to be operated in an environment with cool temperatures (i.e., a winter mode), the hybrid desalination system includes a condenser for receiving seawater and producing cooled seawater therefrom. A reverse osmosis filtration system is in fluid communication with the condenser for receiving the cooled seawater and producing a first brine reject stream therefrom. A multi-effect distillation system receives steam from an external source and outputs a second brine reject stream.

A forward osmosis filtration system is in fluid communication with both the reverse osmosis filtration system and the multi-effect distillation system. The first brine reject stream is received by a feed side of the forward osmosis filtration system and the second brine reject stream is received by a draw solution side of the forward osmosis filtration system. The feed side of the forward osmosis filtration system outputs a third brine reject stream and the draw solution side of the forward osmosis filtration system outputs diluted brine.

The multi-effect distillation system is in fluid communication with the forward osmosis filtration system and receives the diluted brine from the draw solution side thereof, such that the multi-effect distillation system outputs a return condensate and a pure water distillate product. The multi-effect distillation system is also in fluid communication with the condenser, such that the condenser receives water vapor produced by the multi-effect distillation system. Condensed water produced by the condenser is mixed with the pure water distillate output from the multi-effect distillation system.

In a second mode, configured to be operated in an environment with warm temperatures (i.e., a summer mode), the reverse osmosis filtration system of the hybrid desalination system receives the seawater and separates the seawater into a first brine reject stream and a permeate. The condenser is in fluid communication with the reverse osmosis filtration system for receiving the first brine reject stream therefrom and producing cooled brine. The multi-effect distillation system receives steam from the external source and outputs a second brine reject stream.

The forward osmosis filtration system is in fluid communication with both the condenser and the multi-effect distillation system, such that the cooled brine is received by the feed side of the forward osmosis filtration system and the second brine reject stream is received by the draw solution side of the forward osmosis filtration system. The feed side of the forward osmosis filtration system outputs a third brine reject stream, and the draw solution side of the forward osmosis filtration system outputs diluted brine.

The multi-effect distillation system is in fluid communication with the forward osmosis filtration system and receives the diluted brine from the draw solution side thereof. The multi-effect distillation system outputs a return condensate and the pure water distillate product. The multi-effect distillation system is also in fluid communication with the condenser. The condenser receives water vapor produced by the multi-effect distillation system, and condensed water produced by the condenser is mixed with the pure water distillate output from the multi-effect distillation system.

These and other features of the present disclosure will become readily apparent upon further review of the following specification and drawings.

### BRIEF DESCRIPTION OF THE DRAWINGS

FIG. 1 is a schematic diagram of a hybrid desalination system operating in a first mode.

FIG. 2 is a schematic diagram of the hybrid desalination system operating in a second mode.

FIG. 3 is a chart showing specific energy consumption as a function of recovery ratio, comparing multiple-effects distillation with reverse osmosis, and with the hybrid desalination system.

Similar reference characters denote corresponding features consistently throughout the attached drawings.

### BEST MODES FOR CARRYING OUT THE INVENTION

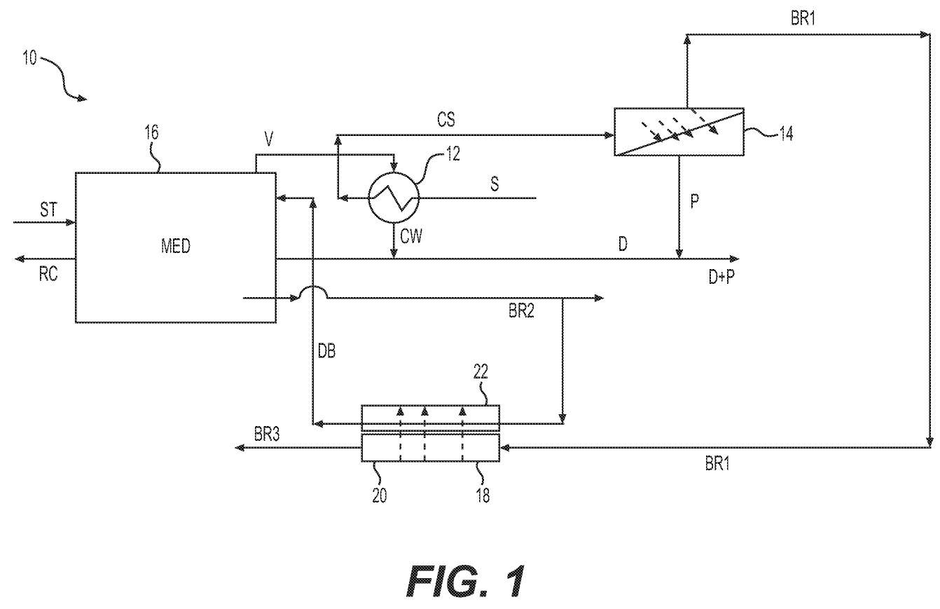

The hybrid desalination system 10 combines a reverse osmosis filtration system and a forward osmosis filtration system with a multi-effect distillation system. FIG. 1 illustrates the hybrid desalination system 10 operating in a first mode, which is configured to be operated in an environment with cool temperatures (i.e., a winter mode). As shown, the hybrid desalination system 10 includes a condenser for receiving seawater S and producing cooled seawater CS therefrom. A reverse osmosis filtration system 14 is in fluid communication with the condenser 12 for receiving the cooled seawater CS and producing a first brine reject stream BR1 therefrom. Preferably, the cooled seawater CS is chemically treated prior to input to the reverse osmosis filtration system 14, as is well-known in the art. A multi-effect distillation (MED) system 16 receives steam ST from an external source and outputs a second brine reject stream BR2.

A forward osmosis filtration system 18 is in fluid communication with both the reverse osmosis filtration system 14 and the multi-effect distillation system 16. The first brine reject stream BR1 is received by a feed side 20 of the forward osmosis filtration system 18 and the second brine reject stream BR2 is received by a draw solution side 22 of the forward osmosis filtration system. The feed side 20 of the forward osmosis filtration system 18 outputs a third brine reject stream BR3 and the draw solution side 22 of the forward osmosis filtration system 18 outputs diluted brine DB. In the forward osmosis filtration system 18, due to the osmotic pressure difference between the highly concentrated brine (i.e., the second brine reject stream BR2) and the feed side 20 (i.e., the reverse osmosis reject brine BR1), pure water transfers from the feed side 20 to the draw solution side 22. The draw solution, which includes sodium chloride (NaCl), is used with synthetic salts to reduce the solute back flux from the feed side 20 to the draw water side 22.

The multi-effect distillation system 16 is in fluid communication with the forward osmosis filtration system 18 and recycles the diluted brine DB from the draw solution side 22, such that the multi-effect distillation system 16 outputs a return condensate RC and a pure water distillate D. Since the forward osmosis filtration system 18 selectively retains the divalent ions from the feed side 20 and allows pure water transport to the concentrated side (i.e., draw side 22), when compared against conventional distillation and/or filtration systems, the top brine temperature (TBT) is able to be increased to a temperature greater than 65° C. The increase of the TBT consequently increases the MED unit distillate production and increases the overall recovery ratio.

The multi-effect distillation system 16 is also in fluid communication with the condenser 12, such that the condenser 12 receives water vapor V produced by the multi-effect distillation system 16. Condensed water CW produced by the condenser 12 is mixed with the pure water distillate D output from the multi-effect distillation system 16. A permeate P produced by the reverse osmosis filtration system 14 is mixed with the pure water distillate D to yield a final water product. By mixing the MED distillate D and the reverse osmosis permeate P, the system 10 is able to make use of only single pass reverse osmosis, compared to conventional double pass reverse osmosis filtration, thus reducing operational costs.

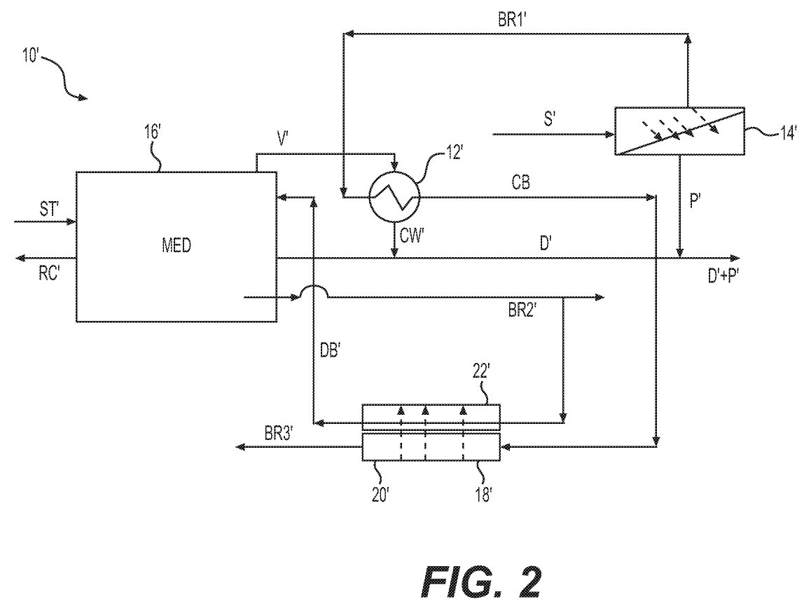

FIG. 2 illustrates an alternative embodiment of the hybrid desalination system 10′, which operates in a second mode (or the hybrid desalination system 10 of FIG. 1 configured to operate in the second mode by the use of valves, pumps, or the like to alter flow through the system 10). The second mode is configured to be operated in an environment with warm temperatures (i.e., in summer mode). The reverse osmosis filtration system 14′ of the hybrid desalination system 10′ receives the seawater S′ and separates the seawater S′ into a first brine reject stream BR1′ and a permeate P′. Preferably, the seawater S′ is first chemically treated prior to input to the reverse osmosis filtration system 14, as is well-known in the art. The condenser 12′ is in fluid communication with the reverse osmosis filtration system 14′ for receiving the first brine reject stream BR1′ and producing cooled brine CB. The multi-effect distillation system 16′ receives the steam ST′ from the external source and outputs a second brine reject stream BR2′.

The forward osmosis filtration system 18′ is in fluid communication with both the condenser 12′ and the multi-effect distillation system 16′, such that the cooled brine CB is received by the feed side 20′ of the forward osmosis filtration system 18′, and the second brine reject stream BR2′ is received by the draw solution side 22′ of the forward osmosis filtration system 18′. The feed side 20′ of the forward osmosis filtration system 18′ outputs a third brine reject stream BR3′, and the draw solution side 22′ of the forward osmosis filtration system 18′ outputs diluted brine DB′. In the forward osmosis filtration system 18′, due to the osmotic pressure difference between the highly concentrated brine (i.e., the second brine reject stream BR2′) and the feed side 20′ (i.e., the cooled brine CB), pure water transfers from feed side 20′ to the draw solution side 22′. The draw solution, which includes sodium chloride (NaCl), is used with synthetic salts to reduce the solute back flux from feed side 20′ to the draw water side 22′.

The multi-effect distillation system 16′ is in fluid communication with the forward osmosis filtration system 18′ and recycles the diluted brine DB′ from the draw solution side 22′. The multi-effect distillation system 16′ outputs a return condensate RC′ and pure water distillate D′. Since the forward osmosis filtration system 18′ selectively retains the divalent ions from the feed side 20′ and allows pure water transport to the concentrated side (i.e., draw side 22′), when compared against conventional distillation and/or filtration systems, the top brine temperature (TBT) is able to be increased to a temperature greater than 65° C. The increase of the TBT consequently increases the MED unit distillate production and increases the overall recovery ratio.

The multi-effect distillation system 16′ is also in fluid communication with the condenser 12′. The condenser 12′ receives water vapor V′ produced by the multi-effect distillation system 16′, and condensed water CW′ produced by the condenser 12′ is mixed with the pure water distillate D′ output from the multi-effect distillation system 16′. Additionally, a permeate P′ produced by the reverse osmosis filtration system 14′ is mixed with the pure water distillate D′ to yield a final water product. By mixing the MED distillate D′ and the reverse osmosis permeate P′, the system 10′ is able to make use of only single pass reverse osmosis, compared to conventional double pass reverse osmosis filtration, thus reducing operational costs.

In order to test the effectiveness of hybrid desalination system 10 (and the alternative mode of hybrid desalination system 10′), simulations were run using visual design and simulation (VDS) software, comparing the present hybrid desalination system against single pass reverse osmosis (RO) filtration alone and multi-effect distillation (MED) alone. For the simulated single pass RO filtration system, the following parameters were used in the simulation. The seawater was fed through the RO filtration system at a fixed rate at 16,000 tons/hour and with a salinity of 45 g/L. This matches expected feed of cooled seawater CS into the RO filtration system 14 of the hybrid desalination system 10. The simulated RO system recovery ratio was 30%.

The RO brine had a salinity of 63 g/L, which, in the present hybrid desalination system 10, would be directed to the feed side 20 of the forward osmosis filtration system 18. The residual chemicals in the brine (beside the available pressure at 5.8 bar) would assist the FO process. The electrical consumption was 3.6 kWh/m³. The low recovery ratio of the RO system alone would decrease the boron effluent in the permeate. The permeate of 4790 tons/hour (25 MIGD) and a salinity of 450 ppm would be blended with the MED distillate in the present hybrid desalination system 10. A pressure exchanger assists the simulated RO high pressure pump and recovers 50% of the brine energy. The simulated RO section included six trains, with each train containing 180 vessels. Each vessel contained seven elements. The RO element was simulated to be 8 inches long with a surface area of 37 m².

Overall, for the RO system alone, the simulated recovery ratio was 0.3, the electrical energy consumed was 5.9 kWh/m³, and the total energy consumption was 5.9 kWh/m³. For a simulated two-pass RO system, such as that described above, the recovery ratio of the first pass was 30% (as in the single pass RO system) and the recovery ratio of the second pass was 90%. The salinity of the final permeate was 25 ppm.

For the simulated MED system, the simulated recovery ratio was 0.3, the electrical energy consumed was 1.73 kWh/m³, the thermal energy expended was 6.2 kWh/m³, and the total energy consumption was 7.93 kWh/m³. By comparison, for the present hybrid desalination system 10, the simulated recovery ratio was 0.43, the electrical energy consumed was 3.0 kWh/m³, the thermal energy expended was 1.2 kWh/m³, and the total energy consumption was only 4.2 kWh/m³. Thus, the recovery ratio of the present hybrid desalination system 10 is up to 43% higher than the standalone RO desalination plant or standalone MED system. The specific total energy consumption of the present hybrid desalination system is also 45% lower than that of the simulated MED plant, and 30% lower than that of the simulated RO desalination plant.

For the simulated hybrid desalination system 10, a distillate of 1940 tons/hour (10 MIGD) was simulated as the product from the MED system. The top brine temperature (TBT) increased to 85° C., and this temperature range allowed the use of 16 effects in the MED system, as opposed to a conventional 10 effect MED plant. As the number of effects increases, the gain output ratio (GOR) increases from 8.7 to 13.3 (i.e., 53% higher). The specific heat transfer surface decreases in area by 10%. The steam flow rate consumption was 146 tons/hour, which is 53% lower than that of a conventional MED plant (i.e., 221 tons/hour). Due to a significant reduction in the heating steam, the equivalent thermal energy decreased by 34%.

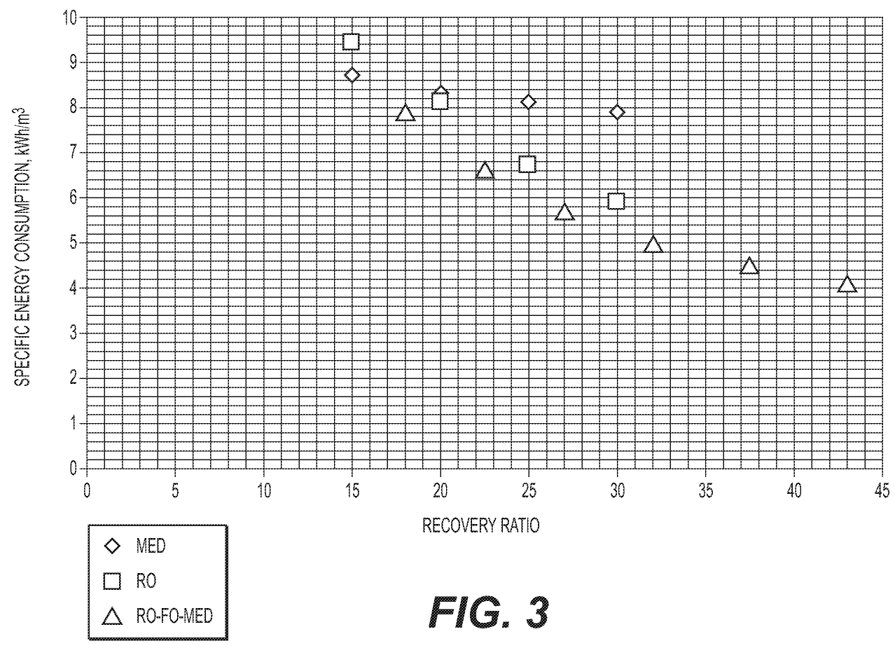

In FIG. 3, the data corresponding to the hybrid desalination system 10, which is a hybrid of reverse osmosis (RO), forward osmosis (FO) and multi-effect distillation (MED), is labeled as “RO-FO-MED”, and is compared against the data taken from the simulated RO system alone, and the simulated MED system alone. Specifically, FIG. 3 plots the energy consumption variation at different values of recovery ratio. As shown, as the recovery ratio increases, the specific energy decreases. As the recovery ratio increases, the capital cost of intake operation and construction will decrease up to 50%, since common intake is used. Further, as noted above, by mixing the MED distillate D and the reverse osmosis permeate, the present hybrid desalination system is able to make use of only single pass reverse osmosis, compared to conventional double pass reverse osmosis filtration, thus reducing operational costs. Additionally, since the RO permeate is diluted by the MED distillate, a concentrated brine waste product is not an issue with the present hybrid desalination system.

It is to be understood that the hybrid desalination system is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A hybrid desalination system, comprising:
a condenser having:
a seawater inlet port adapted for receiving seawater;
a vapor inlet;
a seawater outlet port adapted for producing cooled seawater therefrom; and
a condensed water outlet;
a reverse osmosis filtration system having an inlet side connected to the outlet port of the condenser for receiving the cooled seawater, a brine outlet, and a permeate outlet, the brine outlet being adapted for producing a first brine reject stream therefrom;
a multi-effect distillation system having:
a steam inlet adapted for receiving steam from an external source;
a brine inlet;
a distillate outlet connected to the permeate outlet of the reverse osmosis filtration system to form a combined desalinated water output conduit, the condensed water outlet of the condenser being connected to the combined desalinated water output conduit;
a vapor outlet connected to the vapor inlet of the condenser;
a brine outlet adapted for outputting a second brine reject stream; and
a return condensate outlet; and
a forward osmosis filtration system having a feed side and a draw side, the feed side having a brine inlet connected to the brine outlet of the reverse osmosis filtration system for receiving the first brine reject stream and a brine outlet adapted for outputting a third brine reject stream, the draw side having a brine inlet connected to the brine outlet of the multi-effect distillation system for receiving the second brine reject stream and a brine outlet connected to the brine inlet of the multi-effect distillation system for transferring dilute brine from the forward osmosis filtration system to the multi-effect distillation system.

2. A hybrid desalination system, comprising:
a reverse osmosis filtration system having a seawater inlet port adapted for receiving seawater, a brine outlet port adapted for outputting a first brine reject stream, and a permeate outlet port;
a condenser having:
a brine inlet port connected to the brine outlet port of the reverse osmosis filtration system for receiving the first brine reject stream;
a vapor inlet;
a cooled brine outlet port adapted for outputting the first brine reject stream as cooled brine; and
a condensed water outlet;
a multi-effect distillation system having:
a steam inlet adapted for receiving steam from an external source;
a brine inlet;
a distillate outlet connected to the permeate outlet of the reverse osmosis filtration system to form a combined desalinated water output conduit, the condensed water outlet of the condenser being connected to the combined desalinated water output conduit;
a vapor outlet connected to the vapor inlet of the condenser;
a brine outlet adapted for outputting a second brine reject stream; and
a return condensate outlet; and
a forward osmosis filtration system having a feed side and a draw side, the feed side having a brine inlet connected to the cooled brine outlet of the condenser for receiving the first brine reject stream and a brine outlet adapted for outputting a third brine reject stream, the draw side having a brine inlet connected to the brine outlet of the multi-effect distillation system for receiving the second brine reject stream and a brine outlet connected to the brine inlet of the multi-effect distillation system for transferring dilute brine from the forward osmosis filtration system to the multi-effect distillation system.

3. A method of desalinating seawater, comprising the steps of:
processing the seawater in a condenser to produce a stream of cooled seawater;
filtering the seawater in a reverse osmosis filtration system to produce a first brine reject steam and a permeate stream;
filtering the first brine reject stream through a forward osmosis filtration system to obtain a stream of dilute brine;
inputting the stream of dilute brine to a multiple-effect distillation system to obtain vapor output and a distillate output stream;
processing the vapor output of the multiple-effect distillation system through the condenser to output condensed water; and
combining the permeate stream, the distillate output stream, and the condensed water in a common conduit to provide a combined desalinated water output.

4. The method of desalinating seawater according to claim 3, further comprising the step of recycling a second brine reject stream from the multiple-effect distillation system through a draw side of the forward osmosis filtration system.

5. The method of desalinating seawater according to claim 3, further comprising the step of outputting a third brine reject stream from a feed side of the forward osmosis filtration system.

6. The method of desalinating seawater according to claim 3, further comprising the step of supplying the multiple-effect distillation system with steam from an external source.
